(19) United States
(12) Patent Application Publication
(10) Pub. No.: US 2014/0008963 A1
(43) Pub. Date: Jan. 9, 2014

(54) RIM ROTOR BRAKING SYSTEM

(71) Applicant: W. Cody Franklin, Ogden, UT (US)

(72) Inventor: W. Cody Franklin, Ogden, UT (US)

(21) Appl. No.: 13/934,840

(22) Filed: Jul. 3, 2013

Related U.S. Application Data
(60) Provisional application No. 61/667,792, filed on Jul. 3, 2012.

(51) Int. Cl. B60B 21/08

(52) U.S. Cl. CPC B60B 21/08
USPC 301/6.1

(57) ABSTRACT

A rim rotor braking system has an integrally formed rotor portion that is orientated at 90 degree to the rim. The rotor is compressed between calipers in a braking system that is attached to a portion of a vehicle such as a bicycle fork. The rotor's orientation maximizes heat transfer to the air and allows the braking system to efficiently stop the vehicle. The brake system may be mounted under the fork or adjacent to it. The rim may be made of aluminum, titanium, steel or any other suitable material. The braking mechanism may be mechanical, hydraulic or electric. In one embodiment, dual rotors are disposed on either side of the rim to provide extra braking power. In yet another embodiment, the rotor is replaceable.

### CROSS REFERENCE TO RELATED APPLICATIONS

This application claims priority and herein incorporates by reference U.S. provisional patent application 61/667,792, filed Jul. 3, 2012.

### BACKGROUND OF THE INVENTION

Almost as soon as the wheel was invented, the obvious need for a way to stop was evident. Early brakes consisted of a lever and a pivot point which allowed the user to apply a frictional force to the wheel or axle of the moving wheel. Basically, these early braking systems converted the kinetic energy of movement into heat. Rudimentary braking systems were fine for the speeds of animal powered wagons, but with the onset of the railroad and the automobile, braking systems had to be improved to keep up with the tremendous increase in speeds.

Modern braking systems still generally convert kinetic energy into heat, but some innovative braking systems do utilize other energy conversions such as magnetic fields, flywheels, etc. but all slow the vehicle down by changing the kinetic energy of movement into another form of energy. Early automobile brakes utilized a drum portion that used shoes that could be expanded against the drum. Disc brakes were developed to squeeze a disc between calipers that are forced together to frictionally interact with the disc.

Most bicycles use either a rim brake or a disc brake. Bicycle rim brakes use a caliper, usually a pair on each side of the rim and a mechanism to squeeze the rim between them. Bicycle disc brakes use a disc attached to the wheel hub with calipers that squeeze the disc between them. Both of these brakes have advantages and disadvantages. There is a need for a braking system that maximizes the advantages of the rim brakes with the advantages of the disc brake.

### SUMMARY OF THE INVENTION

A rim rotor braking system has an integrally formed rotor portion that is orientated at 90 degree to the rim. The rotor is compressed between calipers in a braking system that is attached to a portion of a vehicle such as a bicycle fork. The rotor's orientation maximizes heat transfer to the air and allows the braking system to efficiently stop the vehicle. The brake system may be mounted under the fork or adjacent to it. The rim may be made of aluminum, titanium, steel or any other suitable material. The braking mechanism may be mechanical, hydraulic or electric. In one embodiment, dual rotors are disposed on either side of the rim to provide extra braking power. In yet another embodiment, the rotor is replaceable.

Other features and advantages of the instant invention will become apparent from the following description of the invention which refers to the accompanying drawings.

### BRIEF DESCRIPTION OF THE DRAWINGS

FIG. 1 is a side view of a rim rotor braking system according to an embodiment of the invention.

FIG. 2 is a side view of the rim rotor braking system shown in FIG. 1 with a rim brake installed thereon.

FIG. 3 is a cutaway front view of the rim rotor braking system shown in FIG. 2.

FIG. 4 is a side view of the rim rotor braking system shown in FIG. 1 with an alternate rim brake installed thereon.

FIG. 5 is a cutaway front view of the rim rotor braking system shown in FIG. 4.

FIG. 6 is a cutaway front view of a dual rotor braking system according to an embodiment of the invention.

FIG. 7 is a cutaway front view of a replaceable rotor braking system according to an embodiment of the invention.

FIG. 8 is a cutaway front view of a replaceable rotor braking system according to an embodiment of the invention.

### DETAILED DESCRIPTION OF THE INVENTION

In the following detailed description of the invention, reference is made to the drawings in which reference numerals refer to like elements, and which are intended to show by way of illustration specific embodiments in which the invention may be practiced. It is understood that other embodiments may be utilized and that structural changes may be made without departing from the scope and spirit of the invention.

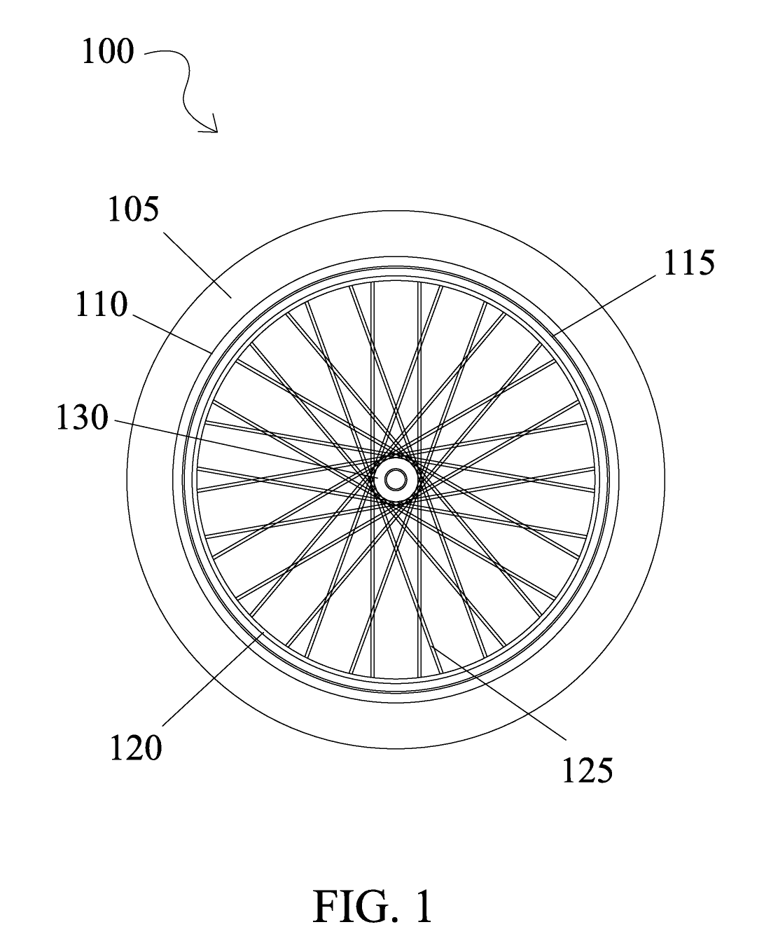

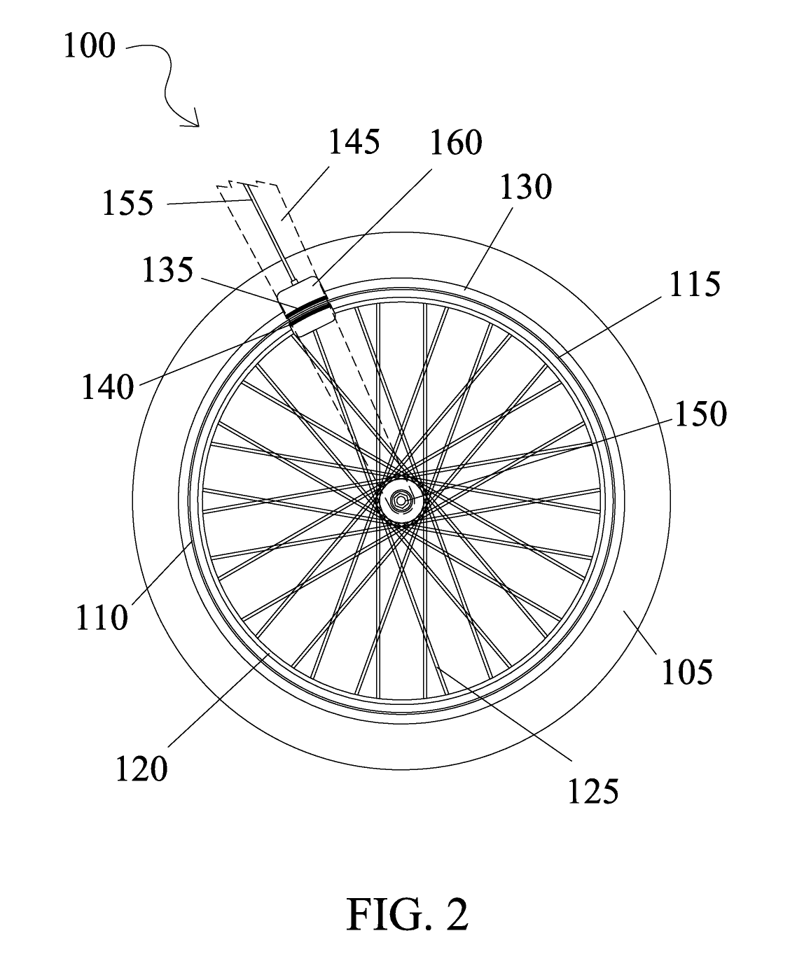

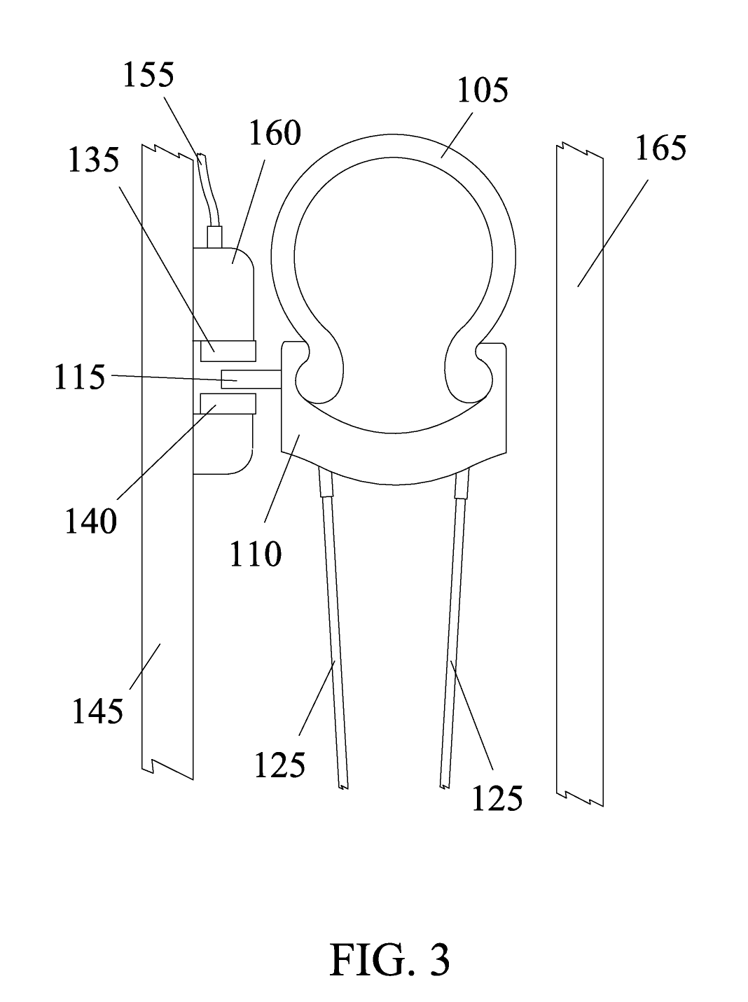

Referring to FIGS. 1-3, a rim rotor braking system 100 is shown having a tire 105 mounted to a rim 110. Rim 110 has a rim rotor 115 integrally formed therein. Rim rotor 115 is generally oriented at a 90 degree angle to the plane of rim 110. Rim 110 has an inner rim portion 120 which connects to a plurality of spokes 125 to keep the rim 110 structurally intact and connected to a hub 130. Of course, other wheels may be used that do not have spokes as long as the wheel uses a rim.

A brake 160 is mounted to an inner side of a brake side fork 145. Rim 110 is mounted between brake side fork 145 and a fork 165 which is connected to hub 130 with a nut 150 which holds an axle (not shown). Brake 160 has an upper caliper 135 and a lower caliper 140 which is manufactured to follow the arc of rim rotor 115. A control connection 155 is provided to control the compression of calipers 135 and 140. The compression can be mechanical or hydraulic or even electric as long as a signal transmitted to brake 160 compresses rim rotor 115 between them. This allows the rim to be used to stop the vehicle and because rim rotor 115 is located at an increased radius from the hub 130, the mechanical advantage of the present invention is greater than the traditional disc brake system. Additionally, because rim rotor 115 is exposed to the air, it is better able to dissipate heat than is possible in a traditional rim braking system. Control connection 155 may be a control cable for transmitting a mechanical force or a wire for transmitting an electric signal depending on the kind of braking system used to engage with rim rotor 115.

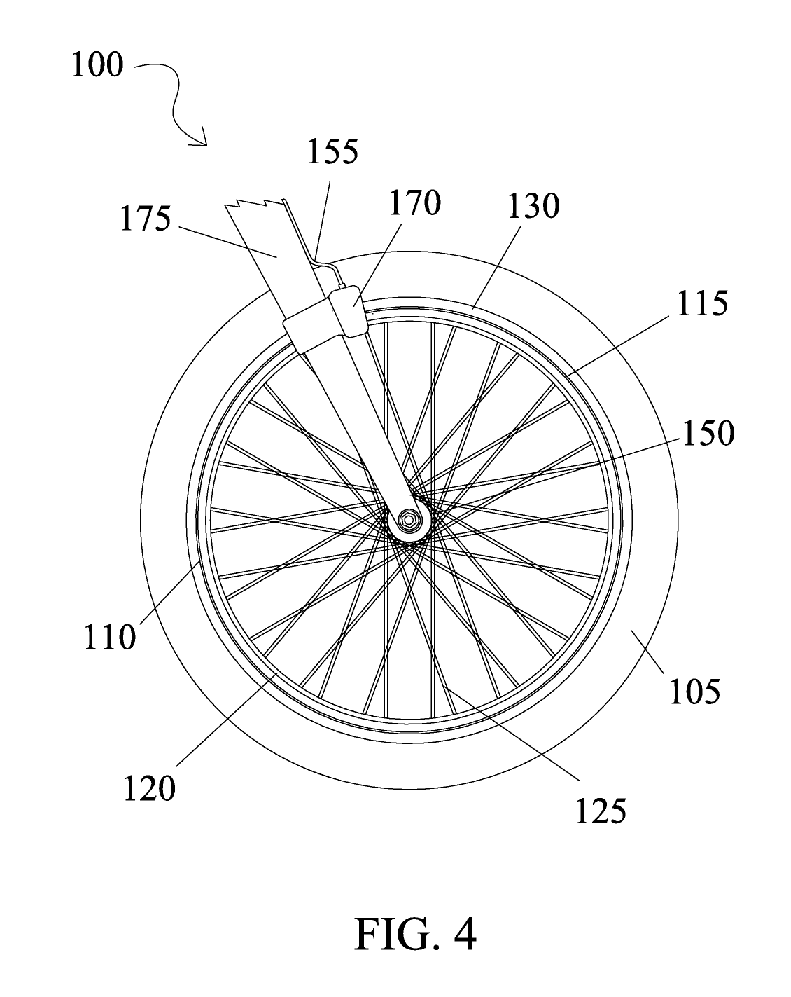

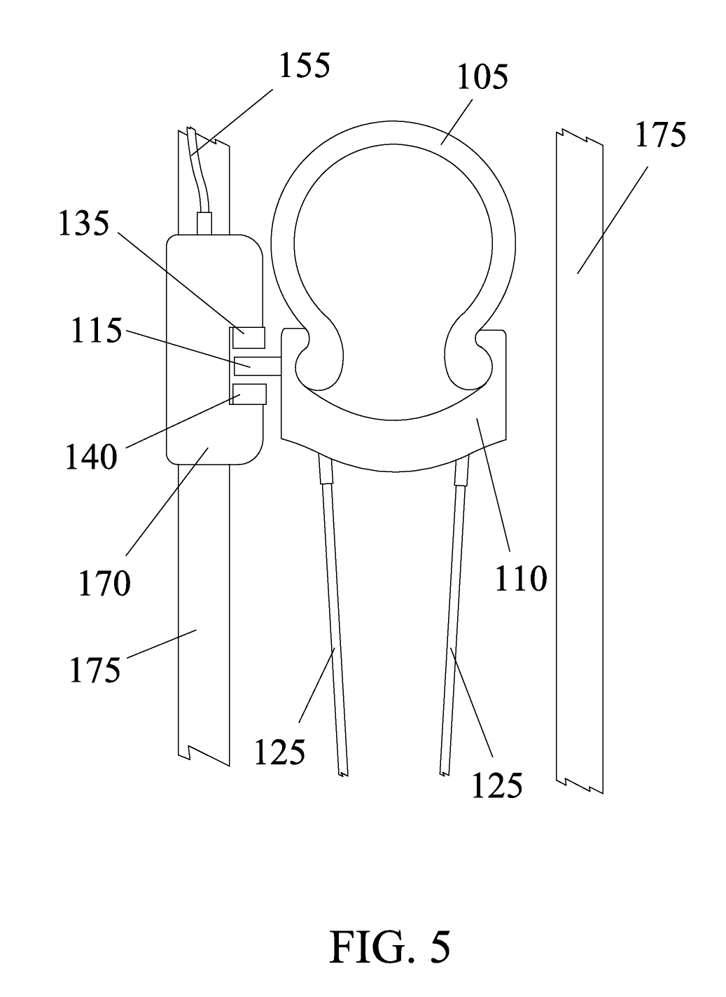

Now referring to FIGS. 4 and 5, an alternative brake 170 is placed adjacent to fork 175 which allows the use of symmetric forks 170. In all other ways, this embodiment functions in the same way as discussed above.

Rim rotor 115 is integrally formed with rim 110 and is made of aluminum. Of course, other materials may be used such as titanium, steel, stainless steel or carbon fiber may be used. Additionally, the rim does not need to have spokes. The only requirement is that a rim rotor portion be integrally formed with the rest of the rim.

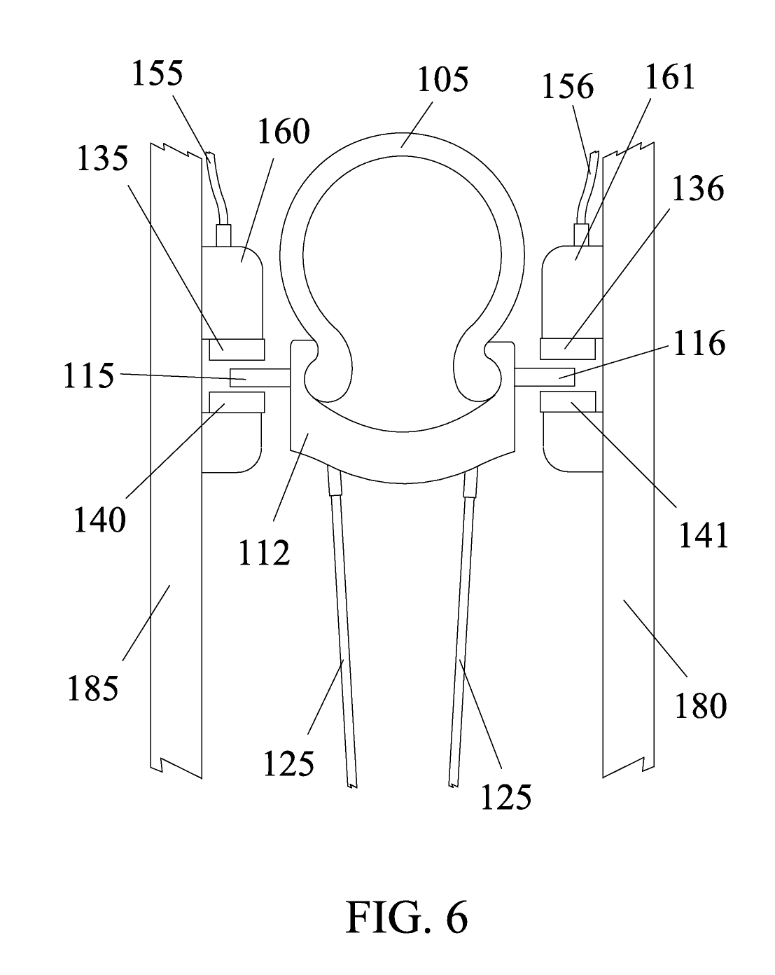

Referring now to FIG. 6, a dual rotor rim 112 is shown having another rim rotor 116 on the opposite side of dual rotor rim 112 with a second brake 161. Brake 160 is mounted on a first fork 185. A second brake 161 has an upper caliper 136 that squeezes rim rotor 116 between a lower caliper 141. Second brake 161 is mounted on a second fork 180.

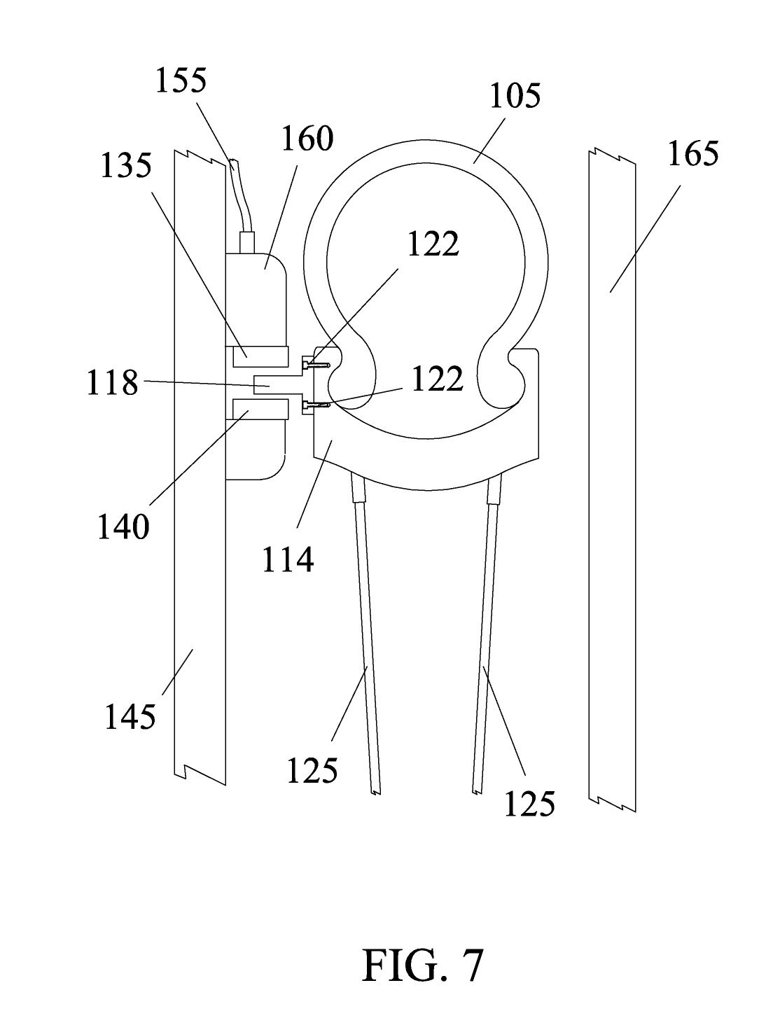

Referring to FIG. 7, a replaceable rotor 118 is shown mounted on a replaceable rotor rim 114 using a plurality of machine screws. In this way, as replaceable rotor 118 wears down or is damaged, it may be replaced. Of course other fastening means may be used such as bolts, rivets etc. as long as replaceable rotor 118 is securely held in place in order to properly operate when compressed by brake 160.

Although, rim rotor braking system 100 is shown mounted on a bicycle wheel, it is understood that the instant invention is applicable to all wheeled vehicles that require a braking function such as, but not limited to, tractors and other farm vehicles, wheeled construction equipment, automobiles, trailers and trucks, etc. Of course, in heavy duty applications, the brake system must be stronger and be able to apply a satisfactory braking force; however, the principle is the same and is understood to be included as part of this disclosure.

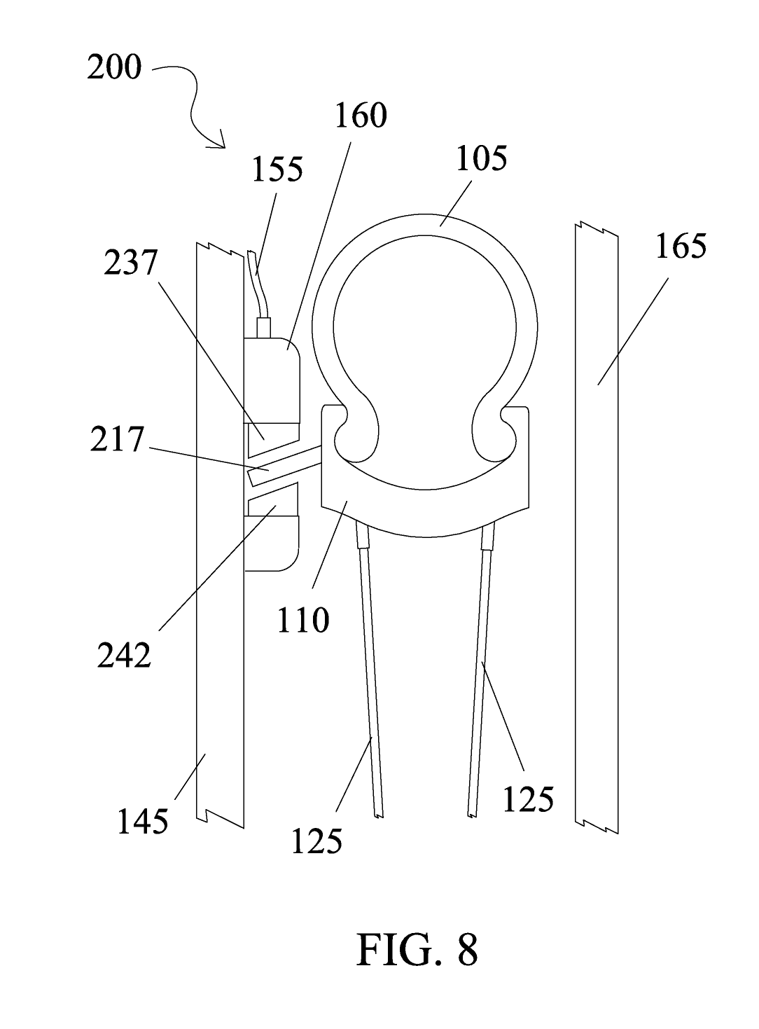

Referring to FIG. 8, a rim rotor braking system 200 is shown having tire 105 mounted to rim 110. Rim 110 has a rim rotor 217 integrally formed therein. Rim rotor 217 is generally oriented at an angle less than 90 degrees to the plane of rim 110. A brake 160 is mounted to an inner side of a brake side fork 145. Rim 110 is mounted between brake side fork 145 and a fork 165. Brake 160 has an upper caliper 237 and a lower caliper 242 which is manufactured to follow the arc of rim rotor 217. A control connection 155 is provided to control the compression of calipers 237 and 242. The angle that rim rotor 217 makes with respect to the plane of rim 110 is selected to meet particular conditions and manufacturing constraints but should be chosen to allow good contact between rim rotor 110 and calipers 237 and 242. Additionally, although rim rotor 217 is shown angled downward, it may also be angled upwards if a specific use would be enhanced.

The compression can be mechanical or hydraulic or even electric as long as a signal transmitted to brake 160 compresses rim rotor 115 between them. In a mechanical embodiment, a brake cable transmits the force necessary to frictionally engage rim rotor 115 between calipers to stop as is known in the art. In the hydraulic embodiment, a control command operates a hydraulic cylinder that provides the force necessary to stop as is known in the art. The control command may be mechanical directly using control connection 155 or an electric signal that energizes a motorized pump. Additionally, servo motors may be used to directly move calipers to stop as is known in the art.

Because rim rotor 115 is located at an increased radius from the hub 130, the mechanical advantage of the present invention is greater than the traditional disc brake system. Additionally, because rim rotor 115 is exposed to the air, it is better able to dissipate heat than is possible in a traditional disk or rim braking system.

Although the instant invention has been described in relation to particular embodiments thereof, many other variations and modifications and other uses will become apparent to those skilled in the art.

What is claimed is:

1. A rim rotor braking system comprising:
a rim;
a rim rotor portion disposed on said rim;
said rim rotor being generally oriented 90 degrees with respect to said rim;
an upper caliper disposed above a top portion of said rim rotor portion;
a lower caliper disposed below a bottom portion of said rim rotor portion and operatively coupled with said upper caliper;
braking means for compressing said rim rotor between said upper caliper and said lower caliper when activated; and
a control means for transmitting a braking command to said braking means.

2. The rim rotor braking system according to claim 1 wherein said braking means comprises a hydraulic braking system.

3. The rim rotor braking system according to claim 2 wherein said control means is a mechanical connection from a brake cable.

4. The rim rotor braking system according to claim 2 wherein said control means is an electric signal from a brake control processor.

5. The rim rotor braking system according to claim 1 wherein said rim rotor is integrally formed as a part of said rim.

6. The rim rotor braking system according to claim 1 wherein said rim rotor is removably attached to said rim.

7. The rim rotor braking system according to claim 1 wherein said rim rotor is attached to said rim with a fastener.

8. The rim rotor braking system according to claim 1 wherein said upper caliper and said lower caliper is contoured to match a circumference portion of said rim rotor.

9. A rim rotor braking system comprising:
a rim having a rim rotor portion circumferentially disposed along a side of said rim wherein said rim rotor is generally perpendicular to a plane of said rim;
a brake assembly adapted to frictionally engage said rim rotor when a braking command is issued; and
a control means for communicating said braking command to said brake assembly.

10. The rim rotor braking system according to claim 9 wherein said brake assembly comprises a pair of opposing calipers adapted to compress said rim rotor between them during a braking process.

11. The rim rotor braking system according to claim 10 wherein said brake assembly utilizes a mechanical linkage operable through a brake cable.

12. The rim rotor braking system according to claim 10 wherein said brake assembly utilizes an electrical connection as said braking command.

13. The rim rotor braking system according to claim 9 wherein said control means is a mechanical connection from a brake cable.

14. The rim rotor braking system according to claim 9 wherein said control means is an electric signal from a brake control processor.

15. A rim rotor braking system comprising:
a rim having a first rim rotor portion circumferentially disposed along a side of said rim wherein said first rim rotor is generally perpendicular to a plane of said rim;
a second rim rotor portion circumferentially disposed along an opposite side of said rim wherein said second rim rotor is generally perpendicular to a plane of said rim;
a first brake assembly adapted to frictionally engage said first rim rotor when a braking command is issued;
a second brake assembly adapted to frictionally engage said second rim rotor when said braking command is issued; and
a control means for communicating said braking command to said first and second brake assemblies.

16. The rim rotor braking system according to claim 15 wherein said control means is a mechanical connection from a brake cable.

17. The rim rotor braking system according to claim 15 wherein said control means is an electric signal from a brake control processor.
